(19) United States
(12) Patent Application Publication
(10) Pub. No.: US 2025/0015946 A1
(43) Pub. Date: Jan. 9, 2025

(54) PAYLOAD INDICATION FOR 802.11BN

(71) Applicants: Qinghua Li, San Ramon, CA (US); Juan Fang, Portland, OR (US); Robert J. Stacey, Portland, OR (US); Shlomi Vituri, Tel Aviv (IL); Danny Alexander, Neve Efraim Monoson (IL); Hao Song, Santa Clara, CA (US)

(72) Inventors: Qinghua Li, San Ramon, CA (US); Juan Fang, Portland, OR (US); Robert J. Stacey, Portland, OR (US); Shlomi Vituri, Tel Aviv (IL); Danny Alexander, Neve Efraim Monoson (IL); Hao Song, Santa Clara, CA (US)

(21) Appl. No.: 18/889,628

(22) Filed: Sep. 19, 2024

Related U.S. Application Data
(60) Provisional application No. 63/584,085, filed on Sep. 20, 2023.

(51) Int. Cl. H04L 5/00; H04W 72/231; H04W 84/12

(52) U.S. Cl. CPC H04L 5/0046; H04W 72/231; H04W 84/12

(57) ABSTRACT

A method and device for providing payload length indication in IEEE 802.11 wireless communications are disclosed. The last OFDM symbol of a transmission is divided into multiple symbol segments and a number of medium access control layer (MAC) and physical layer (PHY) symbol segments are then allocated. The allocated number of MAC symbol segments is indicated using a field in the SIGNAL field or MAC frame body. Mapping between MAC and PHY symbol segments is provided as is additional puncturing for OFDM symbol usage.

### PRIORITY CLAIM

This application claims the benefit of priority to U.S. Provisional Patent Application Ser. No. 63/584,085, filed Sep. 20, 2023, which is incorporated herein by reference in its entirety.

### TECHNICAL FIELD

Embodiments pertain to wireless networks and wireless communications. Some embodiments relate to wireless local area networks (WLANs) and Wi-Fi networks including networks operating under the IEEE 802.11 family of standards. Some embodiments relate to payload indications for IEEE 802.11bn.

### BACKGROUND

It has been shown that the error-prevention performance of 802.11n is better than 802.11ac/ax/be because fewer padding bits are used by 802.11n. However, the use of a reduced number of padding bits comes with a cost; the payload length, the number of bytes in a Physical Layer Convergence Procedure (PLCP) Service Data Unit (PSDU), is indicated in the physical layer (PHY) header using 16 bits. Since the PHY header employs the most robust modulation coding scheme (MCS), 16 bits consumes a significant overhead out of the 34-bit PHY header.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates front-end module (FEM) circuitry in accordance with some embodiments;

FIG. 3 illustrates radio integrated circuit (IC) circuitry in accordance with some embodiments;

FIG. 4 illustrates a functional block diagram of baseband processing circuitry in accordance with some embodiments;

FIG. 5 illustrates a Wireless Local Area Network (WLAN) in accordance with some embodiments;

FIG. 6 is a network diagram illustrating an example network environment, in accordance with some embodiments;

FIG. 7 illustrates a padding structure of 802.11ac/ax/be in accordance with some embodiments;

FIG. 8 illustrates medium access control layer (MAC) allocated symbol segments and PHY allocated symbol segments in the last orthogonal frequency division multiplexing (OFDM) symbol in accordance with some embodiments;

FIG. 9 is a flow diagram of an example method for an enhanced post-FEC system in accordance with some embodiments;

FIG. 10 illustrates a block diagram of an example machine upon which any one or more of the techniques (e.g., methodologies) discussed herein may perform; and

FIG. 11 illustrates a block diagram of an example wireless device upon which any one or more of the techniques (e.g., methodologies or operations) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

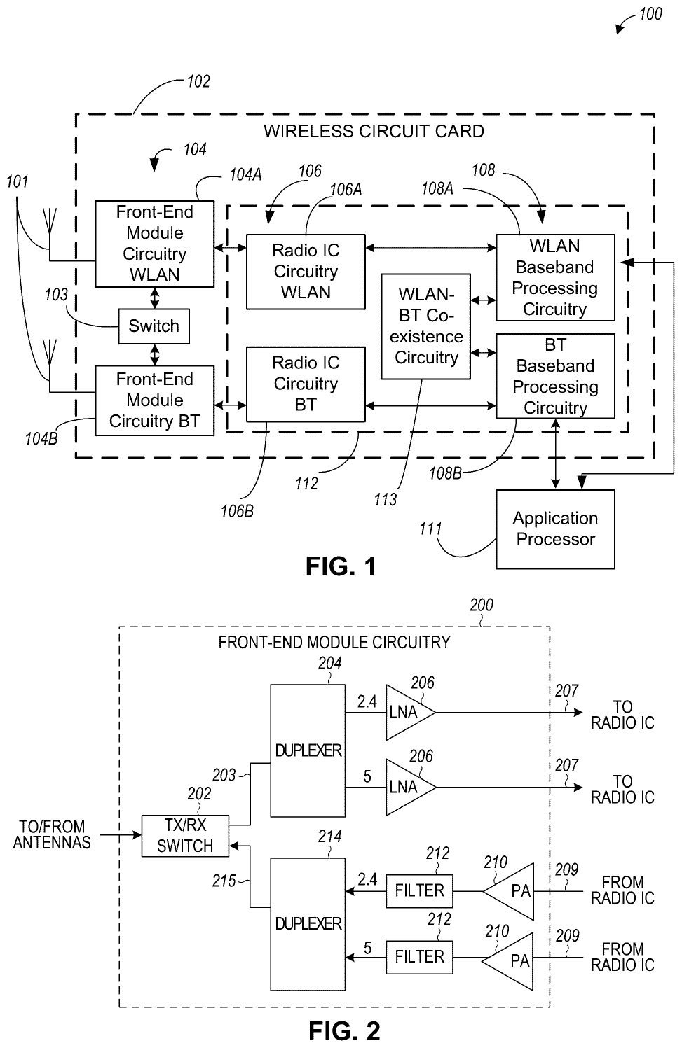

FIG. 1 is a block diagram of a radio architecture 100 in accordance with some embodiments. Radio architecture 100 may include radio front-end module (FEM) circuitry 104, radio IC circuitry 106, and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN (or Wi-Fi) FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals, and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals, and to provide the amplified versions of the received signals to the BT radio IC circuitry 106B for further processing. WLAN FEM circuitry 104A may also include a transmit signal path which may include circuitry configured to amplify WLAN signals provided by the WLAN radio IC circuitry 106A for wireless transmission by the one or more antennas 101. In addition, BT FEM circuitry 104B may also include a transmit signal path which may include circuitry configured to amplify BT signals provided by the radio IC circuitry 106B for wireless transmission by one or more antennas. In the embodiment of FIG. 1, although WLAN FEM circuitry 104A and BT FEM circuitry 104B are shown as being distinct from one another, embodiments are not so limited and include within their scope the use of a FEM (not shown) that includes a transmit path and/or a receive path for both WLAN and BT signals or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the WLAN FEM circuitry 104A and provide baseband signals to WLAN baseband processing circuitry 108A. BT radio IC circuitry 106B may, in turn, include a receive signal path which may include circuitry to down-convert BT RF signals received from the BT FEM circuitry 104B and provide baseband signals to BT baseband processing circuitry 108B. The WLAN radio IC circuitry 106A may also include a transmit signal path which may include circuitry to up-convert WLAN baseband signals provided by the WLAN baseband processing circuitry 108A and provide WLAN RF output signals to the WLAN FEM circuitry 104A for subsequent wireless transmission by one or more antennas 101. BT radio IC circuitry 106B may also include a transmit signal path which may include circuitry to up-convert BT baseband signals provided by the BT baseband processing circuitry 108B and provide BT RF output signals to the BT FEM circuitry 104B for subsequent wireless transmission by the one or more antennas 101. In the embodiment of FIG. 1, although radio IC circuitries 106A and 106B are shown as being distinct from one another, embodiments are not so limited and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband processing circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include a physical layer (PHY) and medium access control layer (MAC) circuitry, and may further interface with the application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband processing circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the one or more antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of the WLAN FEM circuitry 104A or the BT FEM circuitry 104B.

In some embodiments, the FEM circuitry 104, the radio IC circuitry 106, and baseband processing circuitry 108 may be provided on a single radio card, such as wireless radio card 102. In some other embodiments, one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit OFDM or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be a part of a Wi-Fi communication station (STA) such as a wireless access point (AP), a base station, or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax, and/or IEEE 802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW), extremely high throughput (EHT), and ultra high reliability (UHR) communications in accordance with the IEEE 802.11ax, 802.11be, and 802.11bn standards. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband processing circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection-oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as the wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced, or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. However, the scope of the embodiments is not limited concerning the above center frequencies.

FIG. 2 illustrates FEM circuitry 200 in accordance with some embodiments. The FEM circuitry 200 is one example of circuitry that may be suitable for use as the WLAN FEM circuitry 104A and/or the BT FEM circuitry 104B (of FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the FEM circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by the one or more antennas 101 (FIG. 1)). In some multi-mode embodiments for Wi-Fi communication, the FEM circuitry 200 may be configured to operate in any of the 2.4 GHz frequency spectrum, the 5 GHz frequency spectrum, and 6 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and one or more filters 212, such as a BPF, an LPF, or another type of filter for each frequency spectrum and a transmit signal path duplexer 214 to provide the signals of one of the different spectrums onto a single transmit path for subsequent transmission by the one or more antennas 101 (FIG. 1). In some embodiments, BT communications may utilize the 2.4 GHz signal paths and may utilize the same FEM circuitry 200 as the one used for WLAN communications.

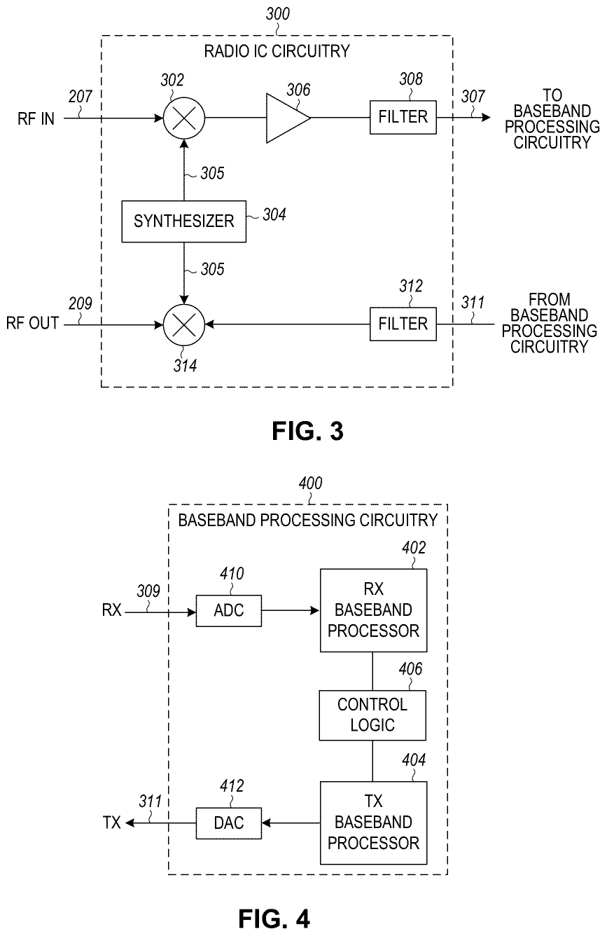

FIG. 3 illustrates radio integrated circuit (IC) circuitry 300 in accordance with some embodiments. The radio IC circuitry 300 is one example of circuitry that may be suitable for use as the WLAN radio IC circuitry 106A or the BT radio IC circuitry 106B (of FIG. 1), although other circuitry configurations may also be suitable.

In some embodiments, the radio IC circuitry 300 may include a receive signal path and a transmit signal path. The receive signal path of the radio IC circuitry 300 may include mixer circuitry 302, such as, for example, down-conversion mixer circuitry, amplifier circuitry 306, and filter circuitry 308. The transmit signal path of the radio IC circuitry 300 may include filter circuitry 312 and mixer circuitry 314, such as up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry and may include, although not shown, embodiments where each of the depicted circuitries may include more than one component. For instance, mixer circuitry 302 and/or 314 may each include one or more mixers, and filter circuitry 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the frequency 305 provided by synthesizer circuitry 304. The amplifier circuitry 306 may be configured to amplify the down-converted signals and the filter circuitry 308 may include an LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert baseband signals 311 based on the frequency 305 provided by the synthesizer circuitry 304 to generate RF signals 209 for the FEM circuitry 104. The baseband signals 311 may be provided by the baseband processing circuitry 108 and may be filtered by filter circuitry 312. The filter circuitry 312 may include an LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature-phase (Q) paths). In such an embodiment, RF signals 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (LO) from a local oscillator or a synthesizer, such as frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in the duty cycle (the percentage of one period in which the LO signal is high) and/or offset (the difference between the start points of the period). In some embodiments, the LO signals may have a 25% duty cycle and a 50% offset. In some embodiments, each branch of the mixer circuitry (e.g., the in-phase (I) and quadrature-phase (Q) path) may operate at a 25% duty cycle, which may result in a significant reduction in power consumption.

The RF signals 207 (FIG. 2) may comprise a balanced signal, although the scope of the embodiments is not limited in this respect. The I and Q baseband output signals may be provided to the low-noise amplifier, such as amplifier circuitry 306 (FIG. 3) or filter circuitry 308 (FIG. 3).

In some embodiments, the output baseband signals 307 and the baseband signals 311 may be analog, although the scope of the embodiments is not limited in this respect. In some alternate embodiments, the output baseband signals 307 and the baseband signals 311 may be digital. In these alternate embodiments, the radio IC circuitry may include an analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or the application processor 111 (FIG. 1) depending on the desired output frequency. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as frequency 305, while in other embodiments, frequency 305 may be a fraction of the carrier frequency (e.g., one-half the carrier frequency, one-third the carrier frequency). In some embodiments, frequency 305 may be a LO frequency (LO).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor 402 for processing receive baseband signals 309 provided by the radio IC circuitry 106 (FIG. 1) and a transmit baseband processor 404 for generating baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the receive baseband processor 402. In these embodiments, the baseband processing circuitry 400 may also include DAC 412 to convert digital baseband signals from the transmit baseband processor 404 to analog baseband signals.

In some embodiments that communicate OFDM signals or OFDMA signals, such as through the WLAN baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the one or more antennas 101 (FIG. 1) may each comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the antennas may be effectively separated to take advantage of spatial diversity and the different channel characteristics that may result. The one or more antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

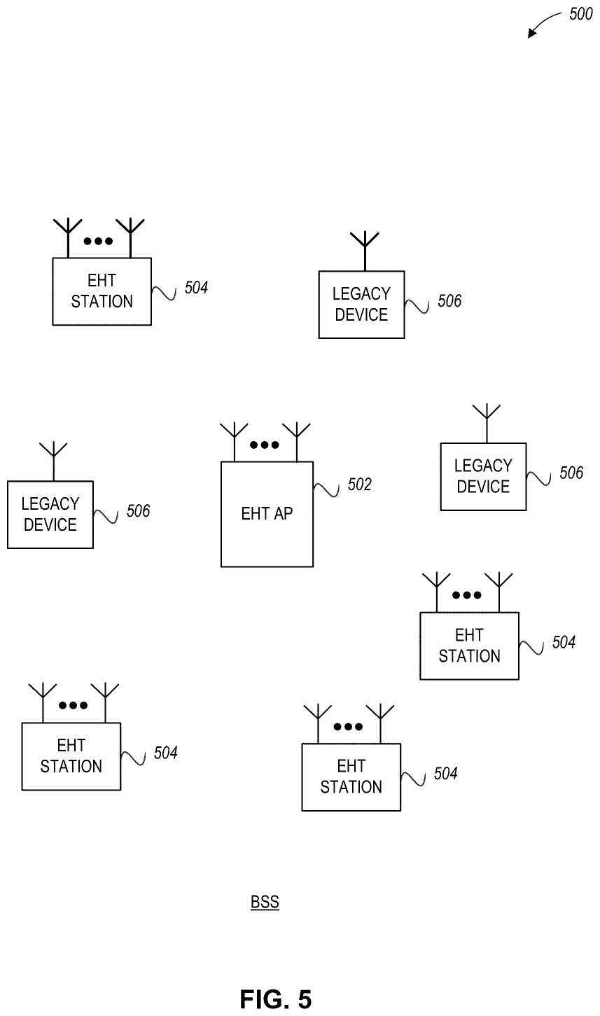

FIG. 5 illustrates a WLAN 500 in accordance with some embodiments. The WLAN 500 may comprise a basis service set (BSS) that may include an EHT access point (AP) 502, which may be termed an AP, a plurality of extremely high throughput (EHT) (e.g., IEEE 802.11be) stations (STAs) 504, and legacy devices 506 (e.g., IEEE 802.11g/n/ac/ax devices). In some aspects, AP 502 is a UHR AP. In some embodiments, the UHR STAs 504 and/or AP 502 are configured to operate in accordance with IEEE 802.11bn. In some embodiments, the UHR STAs 504 and/or AP 502 are configured to operate in accordance with IEEE 802.11bn. In some embodiments, IEEE 802.11bn UHR may be termed Next Generation 802.11. In some embodiments, the AP 502 may be configured to operate a UHR BSS, ER BSS, and/or a BSS. Legacy devices may not be able to operate in the UHR BSS and beacon frames in the UHR BSS may be transmitted using UHR PPDUs. An ER BSS may use ER PPDUs to transmit the beacon frames and legacy devices 506 may not be able to decode the beacon frames and thus are not able to operate in an ER BSS. The BSSs, e.g., BSS, ER BSS, and UHR BSS may use different BSSIDs.

The AP 502 may be an AP using IEEE 802.11 to transmit and receive. The AP 502 may be a base station. The AP 502 may use other communications protocols as well as the IEEE 802.11 protocol. The IEEE 802.11 protocol may be IEEE 802.11bn. The IEEE 802.11 protocol may be IEEE 802.11 next generation. The UHR protocol may be termed a different name in accordance with some embodiments. The IEEE 802.11 protocol may include using OFDMA, time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to more than one UHR APs and may control more than one BSS, e.g., assign primary channels, colors, etc. AP 502 may be connected to the Internet. The AP 502 and/or UHR STA 504 may be configured for one or more of the following: 320 MHz bandwidth, 16 spatial streams, multi-band or multi-stream operation, and 4096 QAM. Additionally, the AP 502 and/or UHR STA 504 may be configured for generating and processing UHR PPDUs that include an extension of the PE field (e.g., a dummy OFDM symbol) (e.g., as disclosed in conjunction with the figures herein) to meet both PHY and MAC processing time requirements.

The legacy devices 506 may operate in accordance with one or more of IEEE 802.11 a/b/g/n/ac/ax/bc/ad/af/ah/aj/ay, or another legacy wireless communication standard. The legacy devices 506 may be STAs or IEEE STAs. In some embodiments, when the AP 502 and UHR STAs 504 are configured to operate in accordance with IEEE 802.11bn UHR, the legacy devices 506 may include devices that are configured to operate in accordance with IEEE 802.11ax or 802.11be. The UHR STAs 504 may be wireless transmit and receive devices such as cellular telephones, portable electronic wireless communication devices, smart telephones, handheld wireless devices, wireless glasses, wireless watches, wireless personal devices, tablets, or another device that may be transmitting and receiving using the IEEE 802.11 protocol such as IEEE 802.11bn or another wireless protocol.

The AP 502 may communicate with legacy devices 506 in accordance with legacy IEEE 802.11 communication techniques. In example embodiments, the AP 502 may also be configured to communicate with UHR STAs 504 in accordance with legacy IEEE 802.11 communication techniques.

In some embodiments, a EHT or UHR frame may be configurable to have the same bandwidth as a channel. The EHT or UHR frame may be a Physical Layer Convergence Procedure (PLCP) Protocol Data Unit (PPDU). In some embodiments, there may be different types of PPDUs that may have different fields and different physical layers, and/or different MAC layers. For example, a single-user (SU) PPDU, multiple-user (MU) PPDU, extended-range (ER) SU PPDU, and/or trigger-based (TB) PPDU. In some embodiments, UHR PPDUs may be the same or similar to EHT PPDUs.

The bandwidth of a channel may be 20 MHz, 40 MHz, or 80 MHz, 80+80 MHz, 160 MHz, 160+160 MHz, 320 MHz, 320+320 MHz, and 640 MHz bandwidths. In some embodiments, the bandwidth of a channel less than 20 MHz may be 1 MHz, 1.25 MHz, 2.03 MHz, 2.5 MHz, 4.06 MHz, 5 MHz, and 10 MHz, or a combination thereof or another bandwidth that is less or equal to the available bandwidth may also be used. In some embodiments, the bandwidth of the channels may be based on several active data subcarriers. In some embodiments, the bandwidth of the channels is based on 26, 52, 106, 242, 484, 996, or 2×996 active data subcarriers or tones that are spaced by 20 MHz. In some embodiments, the bandwidth of the channels is 256 tones spaced by 20 MHz. In some embodiments, the channels are multiple of 26 tones or a multiple of 20 MHz. In some embodiments, a 20 MHz channel may comprise 242 active data subcarriers or tones, which may determine the size of a Fast Fourier Transform (FFT). An allocation of bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz, and 80+80 MHz OFDMA EHT or UHR PPDU formats. In some embodiments, the 106-subcarrier RU is used in the 20 MHz, 40 MHz, 80 MHz, 160 MHz, and 80+80 MHz OFDMA and MU-MIMO EHT or UHR PPDU formats. In some embodiments, the 242-subcarrier RU is used in the 40 MHz, 80 MHz, 160 MHz, and 80+80 MHz OFDMA and MU-MIMO EHT or UHR PPDU formats. In some embodiments, the 484-subcarrier RU is used in the 80 MHz, 160 MHz, and 80+80 MHz OFDMA and MU-MIMO EHT or UHR PPDU formats. In some embodiments, the 996-subcarrier RU is used in the 160 MHz and 80+80 MHz OFDMA and MU-MIMO EHT or UHR PPDU formats.

A UHR or EHT frame may be configured for transmitting several spatial streams, which may be in accordance with MU-MIMO and may be in accordance with OFDMA. In other embodiments, the AP 502, the UHR STAs 504, and/or the legacy devices 506 may also implement different technologies such as code division multiple access (CDMA) 2000, CDMA 2000 1X×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11bc/bn EHT/UHR embodiments, an AP 502 may operate as a master station which may be arranged to contend for a wireless medium (e.g., during a contention period) to receive exclusive control of the medium for a transmission opportunity (TXOP). The AP 502 may transmit an UHR/EHT trigger frame, which may include a schedule for simultaneous UL transmissions from UHR STAs 504. The AP 502 may transmit a time duration of the TXOP and sub-channel information. During the TXOP, UHR STAs 504 may communicate with the AP 502 in accordance with a non-contention-based multiple access technique such as OFDMA or MU-MIMO. This is unlike conventional WLAN communications in which devices communicate in accordance with a contention-based communication technique, rather than multiple access techniques. During the UHR or EHT control period, the AP 502 may communicate with UHR STAs 504 using one or more UHR or EHT frames. During the TXOP, the UHR STAs 504 may operate on a sub-channel smaller than the operating range of the AP 502. During the TXOP, legacy stations refrain from communicating. The legacy stations may need to receive the communication from the AP 502 to defer from communicating.

In accordance with some embodiments, during the TXOP the UHR STAs 504 may contend for the wireless medium with the legacy devices 506 being excluded from contending for the wireless medium during the master-sync transmission. In some embodiments, the trigger frame may indicate a UL-MU-MIMO and/or UL OFDMA TXOP. In some embodiments, the trigger frame may include a DL MU-MIMO and/or DL OFDMA with a schedule indicated in a preamble portion of the PPDU carrying the trigger frame.

In some embodiments, the multiple-access technique used during the UHR or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or UHR STAs 504 in accordance with legacy IEEE 802.11 communication techniques. In some embodiments, the AP 502 may also be configurable to communicate with UHR STAs 504 outside the UHR TXOP in accordance with legacy IEEE 802.11 or IEEE 802.11be/ax EHT/HE communication techniques, although this is not a requirement.

In some embodiments, the UHR STA 504 may be a “group owner” (GO) for peer-to-peer modes of operation. A wireless device may be a HE or EHT or UHR station or an AP 502. In some embodiments, the UHR STA 504 and/or AP 502 may be configured to operate in accordance with IEEE 802.11mc. In example embodiments, the radio architecture of FIG. 1 is configured to implement the UHR STA 504 and/or the AP 502. In example embodiments, the front-end module circuitry of FIG. 2 is configured to implement the UHR STA 504 and/or the AP 502. In example embodiments, the radio IC circuitry of FIG. 3 is configured to implement the UHR STA 504 and/or the AP 502. In example embodiments, the base-band processing circuitry of FIG. 4 is configured to implement the UHR STA 504 and/or the AP 502.

In example embodiments, the UHR STAs 504, AP 502, an apparatus of the UHR STAs 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with the figures herein or may be implemented as part of devices that perform such methods and operations/functions.

In example embodiments, the UHR STA 504 and/or the AP 502 are configured to perform the methods and operations/functions described herein in conjunction with the figures herein. In example embodiments, an apparatus of the UHR STA 504 and/or an apparatus of the AP 502 are configured to perform the methods and functions described herein in conjunction with the figures herein. The term Wi-Fi may refer to one or more of the IEEE 802.11 communication standards. AP and STA may refer to AP 502 and/or UHR STA 504 (or an EHT STA) as well as legacy devices 506.

In some embodiments, a UHR AP STA may refer to an AP 502 and/or an UHR STAs 504 that is operating as a UHR AP. In some embodiments, when an UHR STA 504 is not operating as a UHR AP, it may be referred to as a UHR non-AP STA or UHR non-AP. In some embodiments, UHR STA 504 may be referred to as either a UHR AP STA or a UHR non-AP. UHR may refer to a next-generation IEEE 802.11 communication protocol, which may be IEEE 802.11bn or may be designated another name.

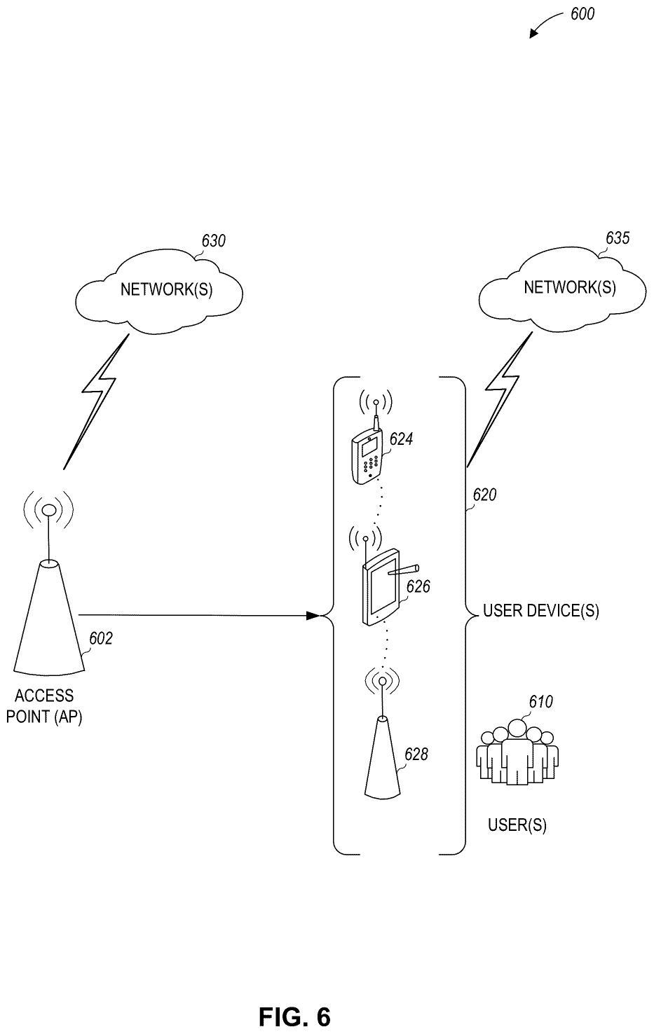

FIG. 6 is a network diagram illustrating an example network environment, in accordance with some embodiments. Wireless network 600 may include one or more user devices 620 and at least one access point (AP) 602, which may communicate in accordance with IEEE 802.11 communication standards. The one or more user devices 620 may be mobile devices that are non-stationary (e.g., not having fixed locations) or may be stationary devices. In some embodiments, the one or more user devices 620 and the at least one AP 602 may include one or more computer systems similar to that of the functional diagram of other figures shown herein.

The one or more user devices 620 and/or at least one AP 602 may be operable by one or more users 610. It should be noted that any addressable unit may be a station (STA). An STA may take on multiple distinct characteristics, each of which shapes its function. For example, a single addressable unit might simultaneously be a portable STA, a quality-of-service (QOS) STA, a dependent STA, and a hidden STA. The one or more user devices 620 and the at least one AP 602 may be STAs. The one or more user devices 620 and/or the at least one AP 602 may operate as a personal basic service set (PBSS) control point/access point (PCP/AP). The one or more user devices 620 (e.g., user device 624, user device 626, or user device 628) and/or the at least one AP 602 may include any suitable processor-driven device including, but not limited to, a mobile device or a non-mobile, e.g., a static device. For example, the one or more user devices 620 and/or the at least one AP 602 may include, user equipment (UE), an STA, an AP, or another device. The one or more user device 620 and/or the at least one AP 602 may also include mesh stations in, for example, a mesh network, in accordance with one or more IEEE 802.11 standards and/or 3GPP standards.

Any of the one or more user devices 620 (e.g., user devices 624-628) and the at least one AP 602 may be configured to communicate with each other via one or more communications networks 630 and/or 635, which can be wireless or wired networks. The one or more user devices 620 may also communicate peer-to-peer or directly with each other with or without the at least one AP 602. Any of the one or more communications networks 630 and/or 635 may include but is not limited to, any one of a combination of different types of suitable communications networks such as broadcasting networks, cable networks, public networks (e.g., the Internet), private networks, wireless networks, cellular networks, or any other suitable private and/or public networks.

Any of the one or more user devices 620 (e.g., user devices 624-628) and the at least one AP 602 may include one or more communications antennas. The one or more communications antennas may be any suitable type of antenna corresponding to the communications protocols used by the one or more user devices 620 (e.g., user devices 624-628), and the at least one AP 602. Some non-limiting examples of suitable communications antennas include Wi-Fi antennas, the IEEE 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the one or more user devices 620 and/or the at least one AP 602.

Any of the one or more user devices 620 (e.g., user devices 624-628) and the at least one AP 602 may be configured to perform directional transmission and/or directional reception in conjunction with wirelessly communicating in a wireless network. Any of the one or more user devices 620 (e.g., user devices 624-628) and the at least one AP 602 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the one or more user devices 620 (e.g., user devices 624-628), and the at least one AP 602 may be configured to perform any given directional transmission towards one or more defined transmit sectors. Any of the one or more user devices 620 (e.g., user devices 624-628) and the at least one AP 602 may be configured to perform any given directional reception from one or more defined receive sectors.

MIMO beamforming in a wireless network may be accomplished using RF beamforming and/or digital beamforming. In some embodiments, in performing a given MIMO transmission, any of the one or more user devices 620 (e.g., user devices 624-628) and the at least one AP 602 may be configured to use all or a subset of its one or more communications antennas to perform MIMO beamforming.

Any of the one or more user devices 620 (e.g., user devices 624-628) and the at least one AP 602 may include any suitable radio and/or transceiver for transmitting and/or receiving radio frequency (RF) signals in the bandwidth and/or channels corresponding to the communications protocols utilized by any of the one or more user devices 620 and the at least one AP 602 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax, 802.11be), 5 GHz channels (e.g., 802.11n, 802.11ac, 802.11ax, 802.11be), or 60 GHz channels (e.g. 802.11ad, 802.11ay). 700 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 702.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband. IEEE draft specification IEEE P802.11be/D4.1, September 2023 is incorporated herein by reference in its entirety.

As above, a recent version of the IEEE 802.11 family for WLAN is 802.11bn, which may support multiple bands (2.4 GHz, 5 GHz, and 6 GHz), bandwidths as large as 320 MHz, and data subcarrier modulation up to 4096 quadrature amplitude modulation (QAM). Low-density parity check (LDPC) coding is also used for error correction when data is transmitted over physical (PHY) layer protocol data units (PPDU). PPDUs contain, in addition to the data, a preamble with multiple fields that provide demodulation information, as well as other information for reception.

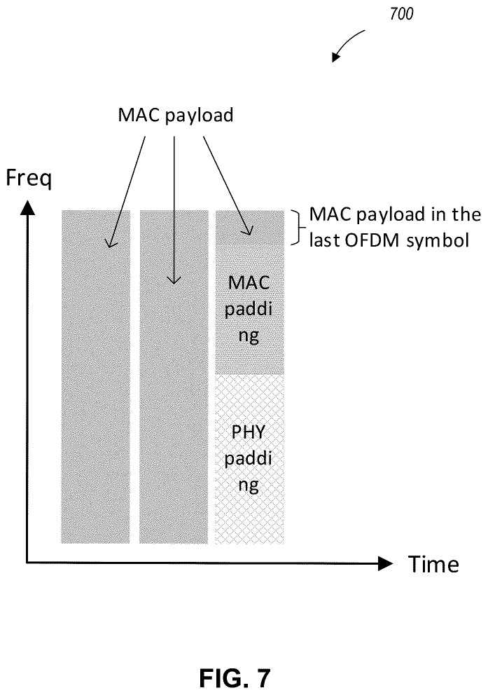

FIG. 7 illustrates a padding structure of 802.11ac/ax/be in accordance with some embodiments. As shown in the structure 700 shown in FIG. 7, the padding of 802.11ac/ax/be includes MAC padding and PHY padding, which are referred to as pre-FEC padding (or pre-end-of-frame (EOF) padding) and post-FEC padding, respectively. Both types of padding take away transmission power from the useful payload of the last OFDM symbol such that the error-prevention performance is degraded.

FEC is a digital signal processing method that improves the bit error rate of communication links by adding redundant information (parity bits) to the data at the transmitter side so that the receiver side then uses the redundant information to detect and correct errors that may have been introduced in the transmission. An encoder in the transmitting wireless device receives and encodes input data. The encoder includes a FEC encoder, which may include a binary convolution code (BCC) encoder followed by a puncturing device and/or a LDPC encoder. Pre-FEC padding and post-FEC padding fill the last OFDM symbol of the data being transmitted, and a packet extension (PE) is added to secure more receiver processing time, which may depend on the capacity of the receiver to return, for example, the corresponding Acknowledgment (ACK) frame within a Short Interframe Space (SIFS) time. A pre-FEC padding process including both pre-FEC MAC and pre-FEC PHY padding is applied before conducting FEC coding, and a post-FEC PHY padding process is appended to the FEC encoded bits. Four pre-FEC padding boundaries partition the last OFDM symbol of a HE PPDU into four symbol segments. The pre-FEC padding may pad toward one of the four possible boundaries. The four pre-FEC padding boundaries are represented by a pre-FEC padding factor parameter, which is denoted by ‘a’.

Pre-FEC padding and post-FEC padding mechanisms are thus used to ensure efficient use of transmission resources and maintain the integrity of data packets. In more detail, Pre-FEC padding, also known as MAC padding, is applied at the MAC layer before the data undergoes FEC encoding. This padding is used to align the MAC frame to the appropriate size for efficient encoding and transmission. In 802.11ac/ax/be, pre-FEC padding is added to the end of the MAC frame to reach a specific length determined by the pre-FEC padding factor. This factor typically allows for padding up to approximately a quarter of the OFDM symbol payload. Post-FEC padding, also referred to as PHY padding, is applied at the PHY layer after the FEC encoding process. This padding is used to fill any remaining space in the last OFDM symbol of a transmission. Post-FEC padding ensures that the transmitted signal fully occupies the allocated time and frequency resources, maintaining synchronization and spectral efficiency.

In the transmission process, the MAC layer first applies pre-FEC padding to the data frame. The padded frame then undergoes FEC encoding at the PHY layer. After encoding, if the resulting data does not completely fill the last OFDM symbol, post-FEC padding is added. During reception, the process is reversed: the receiver first removes the post-FEC padding, then decodes the FEC-encoded data, and finally removes the pre-FEC padding to extract the original MAC frame.

The figures herein, such as FIG. 7, are illustrative only. In practice, as noted above, the signals of an LDPC codeword are not localized. Instead, the signals are distributed over the transmitted band by an interleaver that includes a segment parser and tone mapper. In addition, a packet extension may follow the last OFDM symbol carrying the data signal or post-FEC padding. The packet extension may be increased for the schemes herein due to the increased complexity of the schemes.

In the existing OFDM framing process, when the puncturing and shortening of the LDPC codewords are below predetermined percentage thresholds, no LDPC extra symbol segment for 802.11ax/be and no LDPC extra OFDM symbol for 11ac are used. In this case, the MAC padding is padded to the end of the segment indicated by the pre-FEC padding factor. Otherwise, the MAC padding is padded at the end of the following segment that is indicated by the pre-FEC padding factor. Since the granularity of the pre-FEC padding factor is low, roughly ¼ of the payload of one OFDM symbol, the waste of transmission energy can be up to a quarter of one OFDM symbol. This is significant for packets with less than 4 OFDM symbols. It was reported that packets with about 300 bytes are observed the most often in home applications. These packets are carried by less than 4 OFDM symbols for 80 MHz transmissions. Due to the large percentage of padding, the error prevention performance of 802.11n is better than 802.11ac/ax/be by up to 2 dB. It is undesirable that the new Wi-Fi generations have poorer performances than the older one. The embodiments described herein may thus be used to minimize the MAC padding rather than the PHY padding.

In 802.11n, the number of payload bytes in a PSDU is fully specified by the HT Length field using 16 bits. This can indicate up to 64 kilobytes. The 16 bits consume a large amount of overhead; consequently, this approach was abandoned by the subsequent 802.11ac/ax/be, although 802.11n error-prevention is better than those of 802.11ac/ax/be. However, an 802.11be PSDU can be up to 15.5 megabytes, whose length indication takes 24 bits. A 16-bit field is insufficient to provide the information. We take a different approach in this disclosure for cutting the 24 bits down to few bits, e.g., 3 or 4 bits.

Since a general estimate of the number of payload bytes is able to be derived from the known number of OFDM symbols, the general estimate may be refined by indicating the equivalent, fractional payload amount in the last OFDM. For backward compatibility, the existing fields of LDPC extra symbol segment and pre-Forward Error Correction (FEC) padding factor may be repurposed.

In particular, the number of OFDM symbols can be derived by the receiver, e.g., from the Length field in L-SIG. Therefore, the number of payload bits in all the OFDM symbols except the last OFDM symbol can be derived, e.g., from the MCS. Thus, the payload amount in this portion may or may not be indicated. The indication instead should be the number of payload bytes in the last OFDM symbol.

### Approach 1—Number of Payload Bytes

In this option, the number of payload bytes in the last OFDM symbol may be indicated. Since the MAC payload length is a multiple of 4 bytes (a 4 octet MAC Protocol Data Unit (MPDU) delimiter, followed by a variable octet MPDU, followed by 0-3 octets of padding) in the IEEE 802.11 standard, two bits may be saved by indicating the number of 4 payload bytes instead of 1 payload bytes. Because the number of bits in the previous OFDM symbols may not be a multiple of 4 (or 1) bytes, the remainder bits of the 4 (or 1) bytes may be sent in the last OFDM symbol. The indicated number of 4 (or 1) payload bytes in the last OFDM symbol may not count the remainder bits.

Since the payload of one OFDM symbol can be large, e.g., 4 kilobytes, about 10 bits may be used in this approach to indicate the number of 4 payload bytes. To further reduce the indication bits, the accuracy may be reduced by indicating the number of N payload bytes, where N is an integer greater than 4. For ease of implementation, N may a power of 2, e.g., 16 and 64. If N=64, then about 6 indication bits are used. For the transmission with multiple spatial streams, the payload indication may specify the amount of payload data at the last OFDM symbol in one stream (or all streams).

Approach 1 may be used jointly with Approach 2. For example, the payload size of the last OFDM symbol instead of the whole PPDU may be indicated.

### Approach 2—Refined Division of Last Symbol

In this option, the equivalent fraction consumed by the payload in the last OFDM symbol is indicated because the wasted transmission energy is proportional to the percentage of padding in the last OFDM symbol.

Two sizes are introduced to explain this: the MAC data size and the PHY data signal size. The MAC data includes the MAC payload and MAC padding. The PHY data signal carries the modulated signal, e.g., QAM symbols, generated from the MAC data. For the ease of description, the example of a single spatial stream used (for a multi-stream embodiment, the numbers for the single stream case may be multiplied by the number of streams). Similarly, SU and MU-MIMO modes are used as examples. For an OFDMA mode, the number of data subcarriers per OFDM symbol is changed by the number of data subcarriers per allocated RU, i.e., only the value of one parameter is changed.

In 802.11ax/be, the granularity of the MAC data increment is roughly a quarter of the payload of one OFDM symbol. For example, for an 80 MHz channel with 16 QAM and coding rate ½, one OFDM symbol has 996 subcarriers (with 980 data subcarriers), each subcarrier carries 4 codebits and equivalently 2 information bits. The increment granularity is roughly

$$\frac{1}{4} \times 980 \times 4 \times \frac{1}{2} = 490 bits$$

or a quarter of 80 MHz OFDM symbol. In contrast, the granularity of 802.11n is 8 bits or 1 byte, which is about 62 times finer than 1lax/be. It would be desirable to reduce this gap.

For a fine granularity, the last OFDM symbol may be divided into more than 4 symbol segments. For ease of illustration, 8 segments are used as an example (in practice, 16 or more segments may be desired). Two numbers are defined for the symbol segments, i.e., a MAC allocated symbol segment number and a PHY allocated symbol segment number, which are denoted by N_{Msg} and N_{Psg}, respectively. The MAC allocated symbol segment number is used for calculating the MAC data amount and the PHY allocated symbol segment number specifies how many segments in the last OFDM symbol are filled by the PHY data signal. For example, a 20 MHz channel includes 234 data subcarriers per OFDM symbol, the last OFDM symbol is divided into 8 symbol segments with about 29 data subcarriers per segment, and the total number of data OFDM symbols is 3. In addition, the MCS is 16 QAM with coding rate ½. If the MAC allocated segment number is 1, then total number of MAC data bytes (NBM), which is a multiple of 4 bytes, may be calculated as:

$${N}_{BM} = 4 \times ⌊ \frac{1}{{N}_{bp 4 B}} \times \{ \begin{matrix}[ ( {N}_{OFDM} - 1 ) \times {N}_{dscpo} + {N}_{Msg} \times {N}_{dscpsg} ] \times \\ {N}_{cbpq} \times r - {N}_{service}\end{matrix} \} ⌋ = 4 \times ⌊ \frac{1}{32} \times \{ [ ( 3 - 1 ) \times 234 + 1 \times 29 ] \times 4 \times \frac{1}{2} - 16 \} ⌋$$

where r is the coding rate, N_{bp4B} is the number of information bits per 4 bytes (namely 32), N_{OFDM} is the number of OFDM symbols, N_{dscpo} is the number of data subcarrier per OFDM symbol, N_{Msg} is the number of MAC allocated segments, N_{dscpsg} is the number of data subcarriers per segment (this number may vary with N_{Msg} because each segment may have slightly different numbers of data subcarriers), N_{cbpg} is the number codebits per QAM symbol, N_{service} is the number of service bits, e.g., 16 bits, plus other bits like tail bits for BCC.

The modulated signal of the N_{BM} bytes of MAC data and the service bits fills (N_{OFDM}−1) full OFDM symbols and N_{Psg} segments of the last OFDM symbol. However, note that the size of the MAC symbol segment and the size of the PHY symbol segment may be different. In one extreme example, the MAC may have multiple segments (e.g., 16) but the PHY may only have one segment, i.e., the entire last OFDM symbol as the one segment, in which case the PHY data signal always fills to the end of the last OFDM data symbol. Besides, the last OFDM symbol may have a shorter OFDM symbol duration than the other OFDM symbols for reducing the post-FEC padding such that the last OFDM symbol has fewer data subcarriers than the other OFDM symbol(s).

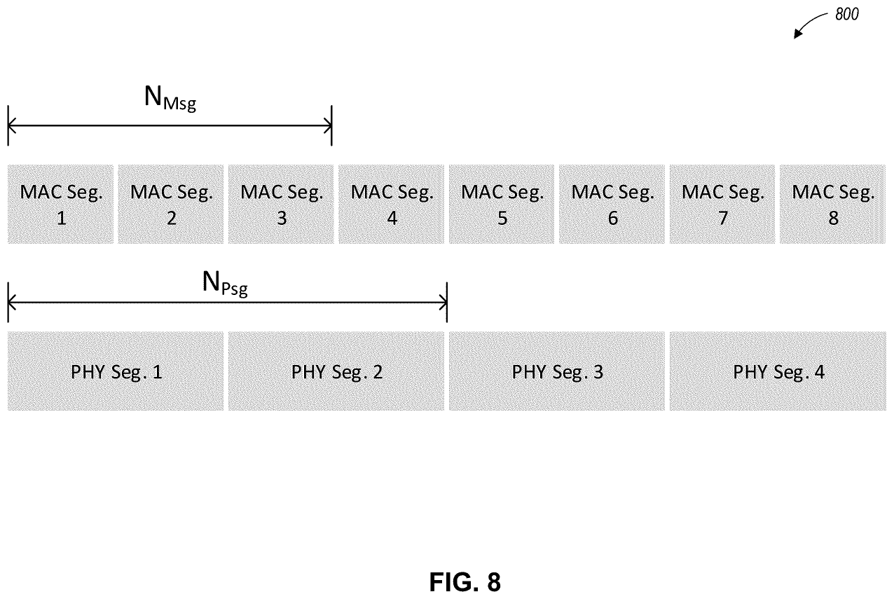

FIG. 8 illustrates MAC allocated symbol segments and PHY allocated symbol segments in the last OFDM symbol in accordance with some embodiments. In FIG. 8, the partial allocations 800 of MAC and PHY at the last OFDM symbol, i.e., N_{Msg} and N_{Psg}, are illustrated. Knowing the N_{Msg} and N_{Psg}, the receiver can calculate the number of MAC data bytes in the PPDU and the number of subcarriers (or codebits or QAM symbols) of the resultant modulated data signal. Together with the existing method, which evenly stretches and punctures each LDPC codeword in the PPDU, the exact locations of the information bits and parity bits are all known.

Apparently, the MAC padding overhead decreases with the size of MAC symbol segment in FIG. 8 because the MAC padding equivalently only fills up the last symbol segment unfinished by the MAC payload. However, the smaller the symbol segment, the more indication bits are used in the SIGNAL field. In contrast, the PHY padding overhead decreases to zero if the last OFDM symbol is filled with PHY data signal. However, the more data signal in the last OFDM symbol, the longer the processing delay. Fortunately, the processing delay does not linearly increase with the amount of data signal in the last OFDM symbol. Instead, the delay increases only slowly with the amount of data signal. Therefore, the PHY symbol segment may be larger.

In the existing 802.11ax/be, two indication fields, i.e., the LDPC extra symbol segment and pre-FEC padding factor, are used to determine N_{Msg} and N_{Psg}. These indication fields may be reused or redefined to increase the granularity of the MAC symbol segment so that the 802.11bn performance can be close to that of 802.11n. In this case, more than 4 MAC symbol segments in the last OFDM symbol may be defined as illustrated in FIG. 8.

To indicate N_{Msg}, instead of 2 bits, the existing pre-FEC padding factor may be expanded to 3 or more bits to increase the granularity of the symbol segment. Alternatively, a new field with 3 or more bits may be defined in the specification to indicate N_{Msg}.

To indicate N_{Psg}, the exiting 802.11ax/be uses a one-bit field, LDPC extra symbol segment, to indicate whether N_{Psg}=N_{Msg} or N_{Psg}=N_{Msg}+1, assuming MAC and PHY have the same symbol segment size. Use of this indication bit may be avoided as, for N_{Msg}<M_{Msg}, where M_{Msg} is the total number of MAC symbol segments in the last OFDM symbol, there is room for the PHY to fill in an extra data signal, e.g., filling one additional symbol segment whose size is the same as one MAC symbol segment. Besides, the mapping between N_{Msg} and N_{Psg} may be defined so that only one of these values is indicated rather than both values being indicated. One example is as follows, where the MAC symbol segments and PHY symbol segments are aligned:

TABLE 1
Mapping between N_{Msg} and N_{Psg}.

| Indication | | | |
|---|---|---|---|
| Index | N_{Msg} | N_{Psg} | Comment |
| 0 | 8 | 8 | Last symbol is fully packed by MAC and PHY |
| | | | without post-FEC padding. |
| 1 | 1 | 3 | MAC data nominally fills ⅛ of the last OFDM |
| | | | symbol and the resultant PHY data signal fills |
| | | | ⅜ of the last OFDM symbol. |
| 2 | 2 | 4 | MAC data nominally fills 2/8 of the last OFDM |
| | | | symbol. The resultant PHY data signal fills 4/8 |
| | | | of the last OFDM symbol. |
| 3 | 3 | 5 | MAC data nominally fills ⅜ of the last OFDM |
| | | | symbol. The resultant PHY data signal fills ⅝ |
| | | | of the last OFDM symbol. |
| 4 | 4 | 6 | MAC data nominally fills 4/8 of the last OFDM |
| | | | symbol. The resultant PHY data signal fills 6/8 |
| | | | of the last OFDM symbol. |
| 5 | 5 | 7 | MAC data nominally fills ⅝ of the last OFDM |
| | | | symbol. The resultant PHY data signal fills ⅞ |
| | | | of the last OFDM symbol. |
| 6 | 6 | 8 | MAC data nominally fills 6/8 of the last OFDM |
| | | | symbol. The resultant PHY data signal fills the |
| | | | whole last OFDM symbol. |
| 7 | 7 | 8 | MAC data nominally fills ⅞ of the last OFDM |
| | | | symbol. The resultant PHY data signal fills the |
| | | | whole last OFDM symbol. |

The MAC and PHY segments in general may or may not be aligned.

N_{Msg} may be indicated in the SIGNAL field of PHY or the payload of MAC like the frame body of a trigger frame. N_{Msg} may or may not be equal or smaller than N_{Psg}. For example, a few more parity bits (e.g., 5%) than the nominal coding rate (e.g., ¾) may be punctured so that one OFDM symbol may be saved by squeezing the MAC data into N-1 OFDM symbols instead of N symbols. An example is as follows.

TABLE 2
Mapping between N_{Msg} and N_{Psg} with the support of
additional puncturing.

| Indication | | | |
|---|---|---|---|
| Index | N_{Msg} | N_{Psg} | Comment |
| 0 | 8 + 5% | 8 | Last symbol is fully packed without post- |
| | nominal | | FEC padding. The effective coding rate is |
| | payload | | higher than the nominal coding rate specified |
| | | | in the MCS index by 5%. Namely, additional |
| | | | puncturing is applied to squeeze the |
| | | | resultant PHY data signal. |
| 1 | 8 | 8 | MAC data nominally fills ⅛ of the last |
| | | | OFDM symbol and the resultant PHY data |
| | | | signal fills the whole last OFDM symbol. |
| 2 | 2 | 4 | MAC data nominally fills 2/8 of the last |
| | | | OFDM symbol. The resultant PHY data |
| | | | signal fills 4/8 of the last OFDM symbol. |
| 3 | 3 | 5 | MAC data nominally fills ⅜ of the last |
| | | | OFDM symbol. The resultant PHY data |
| | | | signal fills ⅝ of the last OFDM symbol. |
| 4 | 4 | 6 | MAC data nominally fills 4/8 of the last |
| | | | OFDM symbol. The resultant PHY data |
| | | | signal fills 6/8 of the last OFDM symbol. |
| 5 | 5 | 7 | MAC data nominally fills ⅝ of the last |
| | | | OFDM symbol. The resultant PHY data |
| | | | signal fills ⅞ of the last OFDM symbol. |
| 6 | 6 | 8 | MAC data nominally fills 6/8 of the last |
| | | | OFDM symbol. The resultant PHY data |
| | | | signal fills the whole last OFDM symbol. |
| 7 | 7 | 8 | MAC data nominally fills ⅞ of the last |
| | | | OFDM symbol. The resultant PHY data |
| | | | signal fills the whole last OFDM symbol. |

In the example of Table 2, for small N_{Msg} (e.g., 1), no table entry is assigned, thereby saving the table entry for greater N_{Msg}. For a small N_{Msg}, the entire OFDM symbol may still be allocated in the PPDU and while plenty of room remains in the OFDM symbol. MAC padding, i.e., pre-FEC padding, can be added to the MAC payload such that the increased MAC data can use a greater N_{Msg} available in the table. The cost of doing this is merely a slight increase of the receiver processing latency.

In Approach 2, the payload size of the last OFDM symbol is used as the baseline for segmentation. Similarly, the payload size of an LDPC codeword can be used as the baseline for the segmentation.

For the two approaches above, the number of data subcarriers of the last OFDM symbol depends on the operation mode. For example, for SU and MU-MIMO, the number of data subcarriers is determined by the channel bandwidth (and the number of spatial steams). In another example, for OFDMA mode, the number of data subcarriers is determined by the allocated RU size (and the number of spatial steams). In yet another example, if the symbol duration of the last OFDM symbol is different from that of the previous OFDM symbol, the number of data subcarriers changes with the OFDM symbol duration as well.

At the cost of moderately increased latency, regardless of the N_{Msg}, the PHY data signal may always fill up the entirety of the last OFDM symbol, e.g., by letting N_{Psg}=M_{Psg}, where M_{Psg} is the total number of PHY symbol segments in the last OFDM symbol. In this case, no post-FEC padding is used.

The indication index in the tables can be included in the PHY preamble, e.g., SIGNAL field, and the MAC frame body, e.g., trigger frame.

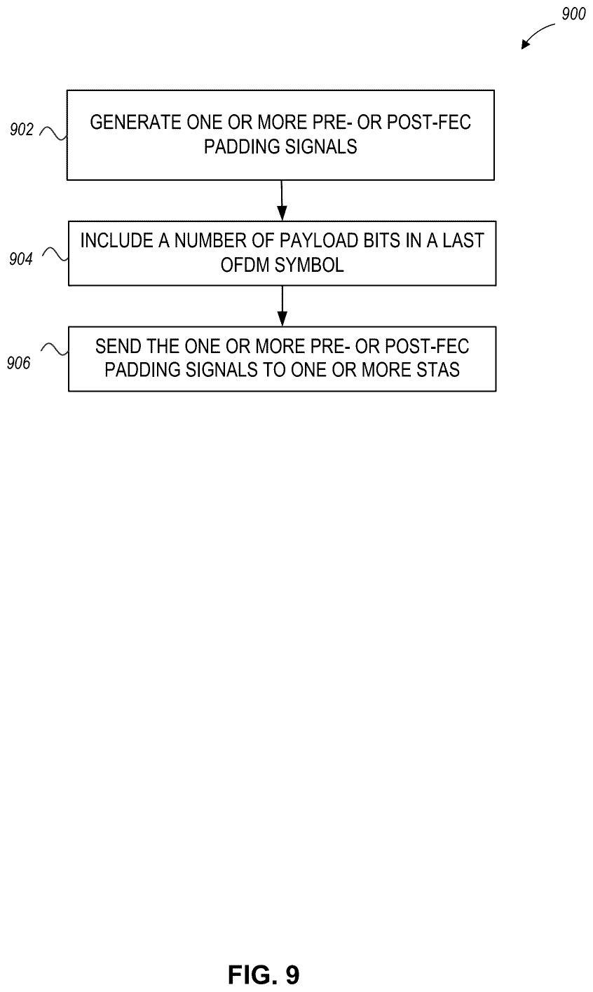

FIG. 9 is a flow diagram of an example method for an enhanced post-FEC system in accordance with some embodiments. Method 900 includes operations 902, 904, and 906, which can be performed by processing circuitry in any of the devices (e.g., STA, AP) described herein.

At operation 902, a device may generate one or more pre- or post-FEC padding signals based on one or more of the embodiments above.

At operation 904, the device may include a number of payload bits in a last (i.e., final) orthogonal OFDM symbol based on one or more of the embodiments above. The indication of the number of payload bits may be in the preamble of a PPDU, and some portion of the preamble has OFDM symbols.

At operation 906, the device may send the one or more pre- or post-FEC padding signals to one or more STAs.

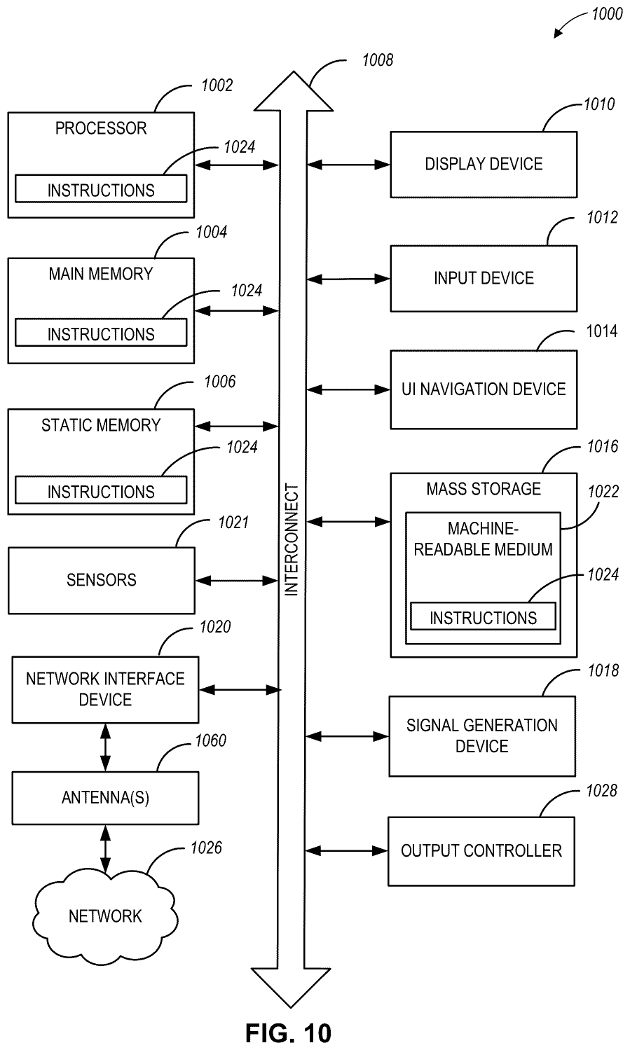

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, machine 1000 may operate in the capacity of a server machine, a client machine, or both in server-client network environments. In an example, machine 1000 may act as a peer machine in a peer-to-peer (P2P) (or other distributed) network environment. The machine 1000 may be an AP 502, UHR station (STA) 504, personal computer (PC), a tablet PC, a set-top box (STB), a personal digital assistant (PDA), a portable communications device, a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1000 may include a hardware processor 1002 (e.g., a central processing unit (CPU), a graphics processing unit (GPU), a hardware processor core, or any combination thereof), a main memory 1004, and a static memory 1006, some or all of which may communicate with each other via an interlink (e.g., bus) 1008.

Specific examples of main memory 1004 include Random Access Memory (RAM), and semiconductor memory devices, which may include, in some embodiments, storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1000 may further include a display device 1010, an input device 1012 (e.g., a keyboard), and a user interface (UI) navigation device 1014 (e.g., a mouse). In an example, the display device 1010, the input device 1012, and the UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensors. The machine 1000 may include an output controller 1028, such as a serial bus (e.g., universal serial bus (USB)), parallel, or other wired or wireless (e.g., infrared (IR), near field communication (NFC), etc.) connection to communicate or control one or more peripheral devices (e.g., a printer, card reader, etc.). In some embodiments, the processor 1002 and/or instructions 1024 may comprise processing circuitry and/or transceiver circuitry.

The storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or the hardware processor 1002 during execution thereof by the machine 1000. In an example, one or any combination of the hardware processor 1002, the main memory 1004, the static memory 1006, or the storage device 1016 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1022 is illustrated as a single medium, the term “machine-readable medium” may include a single medium or multiple media (e.g., a centralized or distributed database, and/or associated caches and servers) configured to store instructions 1024.

An apparatus of the machine 1000 may be one or more of a hardware processor 1002 (e.g., a central processing unit (CPU), a graphics processing unit (GPU), a hardware processor core, or any combination thereof), a main memory 1004 and a static memory 1006, sensors 1021, the network interface device 1020, one or more antennas 1060, a display device 1010, an input device 1012, a UI navigation device 1014, a storage device 1016, instructions 1024, a signal generation device 1018, and an output controller 1028. The apparatus may be configured to perform one or more of the methods and/or operations disclosed herein. The apparatus may be intended as a component of machine 1000 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1000 and that causes the machine 1000 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1024 may further be transmitted or received over a communications network 1026 using a transmission medium via the network interface device 1020 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1020 may include one or more physical jacks (e.g., Ethernet, coaxial, or phone jacks) or one or more antennas to connect to the communications network 1026. In an example, the network interface device 1020 may include one or more antennas 1060 to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques. The term “transmission medium” shall be taken to include any intangible medium that is capable of storing, encoding, or carrying instructions for execution by the machine 1000, and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

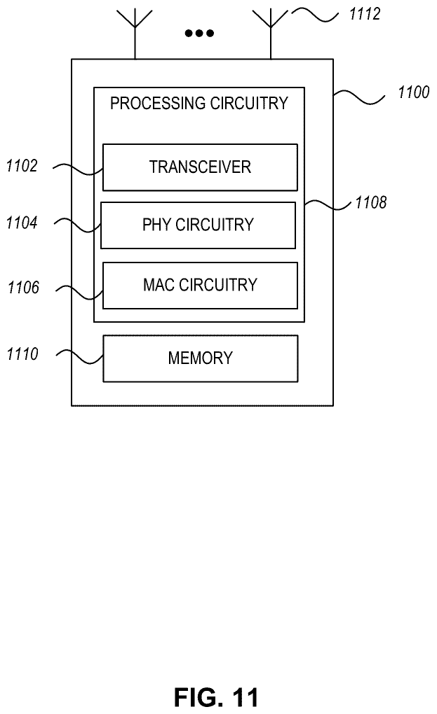

FIG. 11 illustrates a block diagram of an example wireless device 1100 upon which any one or more of the techniques (e.g., methodologies or operations) discussed herein may perform. The wireless device 1100 may be an UHR STA 504, AP 502, and/or a UHR STA or UHR AP. A UHR STA 504, AP 502, and/or a UHR AP or UHR STA may include some or all of the components shown in the figures herein.

The wireless device 1100 may include processing circuitry 1108. The processing circuitry 1108 may include a transceiver 1102, physical layer circuitry (PHY circuitry) 1104, and MAC layer circuitry (MAC circuitry) 1106, one or more of which may enable transmission and reception of signals to and from other wireless devices (e.g., AP 502, UHR STA 504, and/or legacy devices 506) using one or more antennas 1112. As an example, the PHY circuitry 1104 may perform various encoding and decoding functions that may include the formation of baseband signals for transmission and decoding of received signals. As another example, the transceiver 1102 may perform various transmission and reception functions such as the conversion of signals between a baseband range and a Radio Frequency (RF) range.

Accordingly, the PHY circuitry 1104 and the transceiver 1102 may be separate components or may be part of a combined component, e.g., processing circuitry 1108. In addition, some of the described functionality related to the transmission and reception of signals may be performed by a combination that may include one, any, or all of the PHY circuitry 1104 the transceiver 1102, MAC circuitry 1106, memory 1110, and other components or layers. The MAC circuitry 1106 may control access to the wireless medium. The wireless device 1100 may also include memory 1110 arranged to perform the operations described herein, e.g., some of the operations described herein may be performed by instructions stored in memory 1110.

The one or more antennas 1112 (some embodiments may include only one antenna) may comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the one or more antennas 1112 may be effectively separated to take advantage of spatial diversity and the different channel characteristics that may result.

One or more of the memory 1110, the transceiver 1102, the PHY circuitry 1104, the MAC circuitry 1106, the one or more antennas 1112, and/or the processing circuitry 1108 may be coupled with one another. Moreover, although memory 1110, the transceiver 1102, the PHY circuitry 1104, the MAC circuitry 1106, the one or more antennas 1112 are illustrated as separate components, one or more of memory 1110, the transceiver 1102, the PHY circuitry 1104, the MAC circuitry 1106, the one or more antennas 1112 may be integrated into an electronic package or chip.

In some embodiments, the wireless device 1100 may be a mobile device. In some embodiments, the wireless device 1100 may be configured to operate under one or more wireless communication standards as described herein. In some embodiments, the wireless device 1100 may include one or more of the components as described in conjunction with FIG. 10 (e.g., the display device 1010, input device 1012, etc.) Although the wireless device 1100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

In some embodiments, an apparatus of or used by the wireless device 1100 may include various components of the wireless device 1100 as shown in the figures herein. Accordingly, techniques and operations described herein that refer to the wireless device 1100 may apply to an apparatus for a wireless device 1100 (e.g., AP 502 and/or UHR STA 504), in some embodiments. In some embodiments, the wireless device 1100 is configured to decode and/or encode signals, packets, and/or frames as described herein, e.g., PPDUs.

In some embodiments, the MAC circuitry 1106 may be arranged to contend for a wireless medium during a contention period to receive control of the medium for a UHR TXOP and encode or decode a UHR PPDU. In some embodiments, the MAC circuitry 1106 may be arranged to contend for the wireless medium based on channel contention settings, a transmitting power level, and a clear channel assessment level (e.g., energy detect level).

The PHY circuitry 1104 may be arranged to transmit signals following one or more communication standards described herein. For example, the PHY circuitry 1104 may be configured to transmit a HE PPDU. The PHY circuitry 1104 may include circuitry for modulation/demodulation, upconversion/downconversion, filtering, amplification, etc. In some embodiments, the processing circuitry 1108 may include one or more processors. The processing circuitry 1108 may be configured to perform functions based on instructions being stored in a RAM or ROM, or based on special-purpose circuitry. The processing circuitry 1108 may include a processor such as a general-purpose processor or a special-purpose processor. The processing circuitry 1108 may implement one or more functions associated with one or more antennas 1112, the transceiver 1102, the PHY circuitry 1104, the MAC circuitry 1106, and/or the memory 1110. In some embodiments, the processing circuitry 1108 may be configured to perform one or more of the functions/operations and/or methods described herein.

In mm Wave technology, communication between a station (e.g., the UHR stations 504 of FIG. 5 or wireless device 1100) and an access point (e.g., the AP 502 of FIG. 5 or wireless device 1100) may use associated effective wireless channels that are highly directionally dependent. To accommodate the directionality, beamforming techniques may be utilized to radiate energy in a certain direction with a certain beam width to communicate between two devices. The directed propagation concentrates transmitted energy toward a target device to compensate for significant energy loss in the channel between the two communicating devices. Using directed transmission may extend the range of the millimeter-wave communication versus utilizing the same transmitted energy in omnidirectional propagation.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either concerning a particular example (or one or more aspects thereof) or concerning other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each antenna and the antennas of a transmitting station. In some MIMO embodiments, antennas may be separated by up to 1/10 of a wavelength or more.

Described implementations of the subject matter can include one or more features, alone or in combination as illustrated below by way of examples.

### EXAMPLES

Example 1 is an apparatus of a wireless communication device, comprising: a processor configured to: determine that data is to be transmitted to another wireless device using an Institute of Electrical and Electronics Engineers (IEEE) 802.11 protocol; divide a last orthogonal frequency division multiplexing (OFDM) symbol of a transmission into a plurality of symbol segments; allocate a number of medium access control layer (MAC) symbol segments (MAC symbol segment number) and a number of physical layer (PHY) symbol segments (PHY symbol segment number) in a last OFDM symbol; and generate, for transmission to the other wireless device, a signal that includes a field in a preamble of a Physical Layer Convergence Procedure (PLCP) Protocol Data Unit (PPDU) that contains an indication of a number of payload bits in the last OFDM symbol; and a memory configured to store the data.

In Example 2, the subject matter of Example 1 includes, wherein the number of MAC symbol segments is indicated in a pre-FEC padding factor field.

In Example 3, the subject matter of Examples 1-2 includes, wherein the MAC symbol segment number is equal to the PHY symbol segment number, and the processor is configured to fill an entirety of the last OFDM symbol with a PHY data signal without using post-Forward Error Correction (FEC) padding.

In Example 4, the subject matter of Examples 1-3 includes, wherein a number of payload bits in the last OFDM symbol does not include remainder bits of other OFDM symbols.

In Example 5, the subject matter of Examples 1-4 includes, wherein a number of payload bits in the last OFDM symbol is indicated as a multiple of 2^{N} bits, where N is a non-negative number.

In Example 6, the subject matter of Examples 1-5 includes, wherein multiple spatial streams are to be transmitted, the indication specifies an amount of payload data of the last OFDM symbol in one of the spatial streams.

In Example 7, the subject matter of Examples 1-6 includes, wherein multiple spatial streams are to be transmitted, the indication specifies an amount of payload data of the last OFDM symbol in all of the spatial streams.

In Example 8, the subject matter of Examples 1-7 includes, wherein the processor is configured to: divide the last OFDM symbol into at least four segments, calculate a MAC data amount based on the MAC symbol segment number, and determine a number of symbol segments in the last OFDM symbol filled by a PHY data signal based on the PHY symbol segment number.

In Example 9, the subject matter of Example 8 includes, wherein a size of each MAC symbol segment is independent of a size of each PHY symbol segment.

In Example 10, the subject matter of Examples 8-9 includes, wherein an OFDM symbol duration in the last OFDM symbol is shorter than an OFDM symbol duration in other OFDM symbols such that the last OFDM symbol has fewer data subcarriers than the other OFDM symbols.

In Example 11, the subject matter of Examples 8-10 includes, bits to indicate the MAC symbol segment number.

In Example 12, the subject matter of Examples 8-11 includes, wherein the processor is configured to determine one of the MAC symbol segment number or the PHY symbol segment number based on a mapping table between the MAC symbol segment number and the PHY symbol segment number.

In Example 13, the subject matter of Example 12 includes, wherein the mapping table indicates support of additional puncturing of parity bits than puncturing associated with a nominal coding rate to reduce a number of OFDM symbols by one OFDM symbol and does not include an entry for a small MAC symbol segment number.

In Example 14, the subject matter of Example 13 includes, wherein an index of the mapping table that indicates mapping of the MAC symbol segment number and the PHY symbol segment number is disposed in a PHY preamble.

In Example 15, the subject matter of Examples 8-14 includes, wherein the processor is configured to indicate the MAC symbol segment number in a SIGNAL field of a PHY frame or a payload of a MAC frame.

Example 16 is an apparatus of a wireless communication device, comprising: a processor configured to: determine that data is to be transmitted to another wireless device using an IEEE 802.11bn protocol; divide a last orthogonal frequency division multiplexing (OFDM) symbol of a transmission into a plurality of symbol segments; allocate a number of medium access control layer (MAC) symbol segments and a number of physical layer (PHY) symbol segments in a last OFDM symbol; and generate, for transmission to the other wireless device, a signal that includes a field in a preamble of a Physical Layer Convergence Procedure (PLCP) Protocol Data Unit (PPDU) that contains an indication of an equivalent fraction consumed by a payload in the last OFDM symbol.

In Example 17, the subject matter of Example 16 includes, or more bits, and the field is a SIGNAL field or MAC frame body.

In Example 18, the subject matter of Examples 16-17 includes, wherein the processor is configured to map the number of MAC symbol segments to a corresponding number of PHY symbol segments and the mapping comprises selecting the number of PHY symbol segments to be at least the number of MAC symbol segments.

Example 19 is a non-transitory computer-readable storage medium that stores instructions for execution by one or more processors of an apparatus of an access point (AP), the instructions to cause the one or more processors to: determine that data is to be transmitted to another wireless device using an Institute of Electrical and Electronics Engineers (IEEE) 802.11 protocol; divide a last orthogonal frequency division multiplexing (OFDM) symbol of a transmission into a plurality of symbol segments; allocate a number of medium access control layer (MAC) symbol segments (MAC symbol segment number) and a number of physical layer (PHY) symbol segments (PHY symbol segment number) in a last OFDM symbol; and generate, for transmission to the other wireless device, a signal that includes a field that in a preamble of a Physical Layer Convergence Procedure (PLCP) Protocol Data Unit (PPDU) that contains an indication of at least one of a number of payload bits in the last OFDM symbol or an equivalent fraction consumed by a payload in the last OFDM symbol.

In Example 20, the subject matter of Example 19 includes, wherein the instructions further cause the one or more processors to: divide the last OFDM symbol into at least four segments, calculate a MAC data amount based on the MAC symbol segment number, and determine a number of symbol segments in the last OFDM symbol filled by a PHY data signal based on the PHY symbol segment number based on a mapping table between the MAC symbol segment number and the PHY symbol segment number.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a wireless communication device, comprising:
a processor configured to:
determine that data is to be transmitted to another wireless device using an Institute of Electrical and Electronics Engineers (IEEE) 802.11 protocol;
divide a last orthogonal frequency division multiplexing (OFDM) symbol of a transmission into a plurality of symbol segments;
allocate a number of medium access control layer (MAC) symbol segments (MAC symbol segment number) and a number of physical layer (PHY) symbol segments (PHY symbol segment number) in a last OFDM symbol; and
generate, for transmission to the other wireless device, a signal that includes a field in a preamble of a Physical Layer Convergence Procedure (PLCP) Protocol Data Unit (PPDU) that contains an indication of a number of payload bits in the last OFDM symbol; and
a memory configured to store the data.

2. The apparatus of claim 1, wherein the number of MAC symbol segments is indicated in a pre-FEC padding factor field.

3. The apparatus of claim 1, wherein the MAC symbol segment number is equal to the PHY symbol segment number, and the processor is configured to fill an entirety of the last OFDM symbol with a PHY data signal without using post-Forward Error Correction (FEC) padding.

4. The apparatus of claim 1, wherein a number of payload bits in the last OFDM symbol does not include remainder bits of other OFDM symbols.

5. The apparatus of claim 1, wherein a number of payload bits in the last OFDM symbol is indicated as a multiple of 2^{N} bits, where N is a non-negative number.

6. The apparatus of claim 1, wherein multiple spatial streams are to be transmitted, the indication specifies an amount of payload data of the last OFDM symbol in one of the spatial streams.

7. The apparatus of claim 1, wherein multiple spatial streams are to be transmitted, the indication specifies an amount of payload data of the last OFDM symbol in all of the spatial streams.

8. The apparatus of claim 1, wherein the processor is configured to:
divide the last OFDM symbol into at least four segments,
calculate a MAC data amount based on the MAC symbol segment number, and
determine a number of symbol segments in the last OFDM symbol filled by a PHY data signal based on the PHY symbol segment number.

9. The apparatus of claim 8, wherein a size of each MAC symbol segment is independent of a size of each PHY symbol segment.

10. The apparatus of claim 8, wherein an OFDM symbol duration in the last OFDM symbol is shorter than an OFDM symbol duration in other OFDM symbols such that the last OFDM symbol has fewer data subcarriers than the other OFDM symbols.

11. The apparatus of claim 8, wherein a pre-Forward Error Correction (FEC) padding factor is at least 3 bits to indicate the MAC symbol segment number.

12. The apparatus of claim 8, wherein the processor is configured to determine one of the MAC symbol segment number or the PHY symbol segment number based on a mapping table between the MAC symbol segment number and the PHY symbol segment number.

13. The apparatus of claim 12, wherein the mapping table indicates support of additional puncturing of parity bits than puncturing associated with a nominal coding rate to reduce a number of OFDM symbols by one OFDM symbol and does not include an entry for a small MAC symbol segment number.

14. The apparatus of claim 13, wherein an index of the mapping table that indicates mapping of the MAC symbol segment number and the PHY symbol segment number is disposed in a PHY preamble.

15. The apparatus of claim 8, wherein the processor is configured to indicate the MAC symbol segment number in a SIGNAL field of a PHY frame or a payload of a MAC frame.

16. An apparatus of a wireless communication device, comprising:
a processor configured to:
determine that data is to be transmitted to another wireless device using an IEEE 802.11bn protocol;
divide a last orthogonal frequency division multiplexing (OFDM) symbol of a transmission into a plurality of symbol segments;
allocate a number of medium access control layer (MAC) symbol segments and a number of physical layer (PHY) symbol segments in a last OFDM symbol; and
generate, for transmission to the other wireless device, a signal that includes a field in a preamble of a Physical Layer Convergence Procedure (PLCP) Protocol Data Unit (PPDU) that contains an indication of an equivalent fraction consumed by a payload in the last OFDM symbol;
a memory configured to store the data.

17. The apparatus of claim 16, wherein the plurality of symbol segments comprises at least 8 segments, the number of MAC symbol segments is indicated using 3 or more bits, and the field is a SIGNAL field or MAC frame body.

18. The apparatus of claim 16, wherein the processor is configured to map the number of MAC symbol segments to a corresponding number of PHY symbol segments and the mapping comprises selecting the number of PHY symbol segments to be at least the number of MAC symbol segments.

19. A non-transitory computer-readable storage medium that stores instructions for execution by one or more processors of an apparatus of an access point (AP), the instructions to cause the one or more processors to:
determine that data is to be transmitted to another wireless device using an Institute of Electrical and Electronics Engineers (IEEE) 802.11 protocol;
divide a last orthogonal frequency division multiplexing (OFDM) symbol of a transmission into a plurality of symbol segments;
allocate a number of medium access control layer (MAC) symbol segments (MAC symbol segment number) and a number of physical layer (PHY) symbol segments (PHY symbol segment number) in a last OFDM symbol; and
generate, for transmission to the other wireless device, a signal that includes a field that in a preamble of a Physical Layer Convergence Procedure (PLCP) Protocol Data Unit (PPDU) that contains an indication of at least one of a number of payload bits in the last OFDM symbol or an equivalent fraction consumed by a payload in the last OFDM symbol.

20. The medium of claim 19, wherein the instructions further cause the one or more processors to:
divide the last OFDM symbol into at least four segments,
calculate a MAC data amount based on the MAC symbol segment number, and
determine a number of symbol segments in the last OFDM symbol filled by a PHY data signal based on the PHY symbol segment number based on a mapping table between the MAC symbol segment number and the PHY symbol segment number.
